(19) United States
(12) Patent Application Publication
(10) Pub. No.: US 2014/0038161 A1
(43) Pub. Date: Feb. 6, 2014

(54) MULTI-LAYERED COGNITIVE TUTOR

(71) Applicant: APOLLO GROUP, INC., Phoenix, AZ (US)

(72) Inventors: Leslie Wheeler, Pittsburgh, PA (US); Matthew McHenry, Pittsburgh, PA (US); Brendon Towle, Los Angeles, CA (US)

(21) Appl. No.: 13/875,107

(22) Filed: May 1, 2013

Related U.S. Application Data
(60) Provisional application No. 61/678,022, filed on Jul. 31, 2012.
(60) Provisional application No. 61/798,005, filed on Mar. 15, 2013.

(51) Int. Cl. G09B 7/00

(52) U.S. Cl. CPC G09B 7/00
USPC 434/362

(57) ABSTRACT

Techniques are described for problem selection algorithms for providing a multi-layered cognitive tutor. A repository of problems is maintained, which associates the problems with the improvement of corresponding skills according to a cognitive model. User skill levels are maintained in a user profile. Problem sets are then presented to the user in phases, where each phase may utilize different selection criteria for selecting from the repository. By varying the selection criteria between phases, for example from problems testing familiar skills to problems testing new skills, or from problems teaching few skills to problems teaching many skills, problems can be selected to address the unique requirements of each tutoring phase, from beginning to middle to end. Additionally, various secondary criteria such as user interests, category and perceptual classes, problem variety, humorous problems, and other criteria may be used to integrate factors outside of the cognitive model, helping to maintain user engagement.

### CROSS-REFERENCE TO RELATED APPLICATIONS BENEFIT CLAIM

This application claims the benefit of U.S. Provisional Application No. 61/678,022, filed Jul. 31, 2012, and U.S. Provisional Application No. 61/798,005, filed Mar. 15, 2013, which are hereby incorporated by reference in their entirety for all purposes as if fully set forth herein.

### FIELD OF THE INVENTION

The present invention relates to problem selection algorithms for electronic tutoring, and more specifically, to problem selection algorithms for providing a multi-layered cognitive tutor.

### BACKGROUND

To teach a particular concept or to provide practice with a specific subject area, electronic tutoring systems often provide practice problems to be solved by a user. For a more effective tutoring session, instruction should be tailored to the specific strengths and skills of a particular user, for example by providing skill reinforcement in areas needing improvement.

To provide individualized instruction, techniques such as cognitive tutors are utilized, providing users with hands-on learning guided by computational models. These computational models are derived from years of teaching experience for a particular learning domain. With the use of cognitive tutors, users can be guided towards subject matter mastery by practicing problem sets most likely to teach new skills.

However, the selection of problems optimized for fastest skill growth may not be the most appropriate problem selection method in some situations. For example, optimizing for fastest skill growth may generally favor complex problem sets that exercise multiple skills While complex problem sets may be helpful for advanced users already having mastery of basic concepts, such problem sets may prove to be difficult for beginner users.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates the structure of an exemplary course unit section for use by a multi-layered cognitive tutor.

FIG. 2A illustrates a flowchart for processing a course unit section to provide a multi-layered cognitive tutor.

FIG. 2B illustrates a flowchart for processing through phases of a section to provide a multi-layered cognitive tutor.

FIG. 3 is a block diagram of a computer system on which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are described herein for problem selection algorithms for providing a multi-layered cognitive tutor. These techniques may be used to flexibly select candidate problems according to desired skill progression priorities for a specific user skill set. The skill progression priorities may differ based on how far a user has progressed within a particular lesson. For example, a section may be divided into beginning, middle, and end problem set phases, with different skill progression priorities appropriate for each phase.

Once a set of candidate problems is determined based on first criteria, a particular problem to present to the user may be selected, from the set of candidate problems, based on secondary criteria. The selection of problems can be repeated until all problem sets in a section are marked as completed. Each problem set may be marked as completed based on exit criteria that may be uniquely assigned to the problem set. The progression through the problem sets of a particular section may be determined according to a set ordering directive.

### Section Data

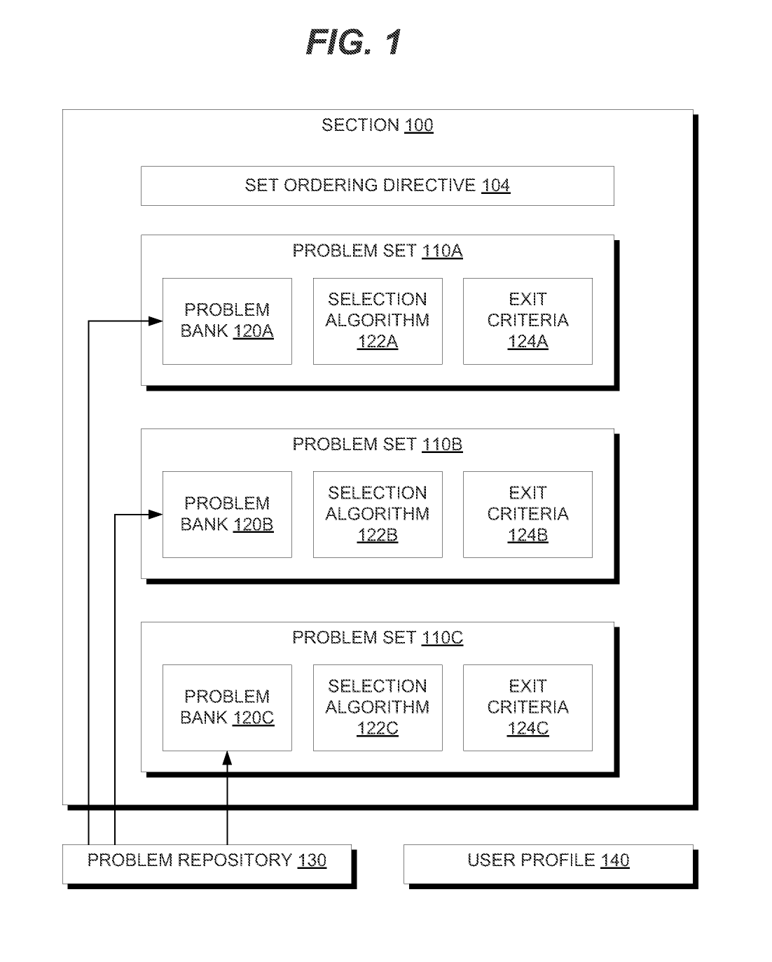

FIG. 1 illustrates the structure of an exemplary course unit section for use by a multi-layered cognitive tutor, according to embodiments. Section 100 may correspond to one of many sections comprising a unit. For example, section 100 may correspond to factoring equations, and the unit may correspond to all problems related to the quadratic equation. In turn, several units may correspond to a course, such as Algebra I. However, for simplicity, FIG. 1 only shows a single section 100.

In the illustrated embodiment, problem repository 130 represents a database of all available problems. Each problem in problem repository 130 may have metadata, derived from a cognitive model, which associates each problem to the growth of particular skills User profile 140 may contain data pertaining to the user to be tutored, including skill mastery levels of the user, tutoring history of the user (including, for example, information about any previously answered problems and completed sections), demographic and preference information, and other user-specific data. Elements of FIG. 1 may be represented in computer memory using stored data organized using arrays, linked lists, graphs, or other data structures that are generated by and managed using computer program logic executed in a host computer, as further described.

Section 100 includes set ordering directive 104, problem set 110a, problem set 110b, and problem set 110c. Problem set 110a includes problem bank 120a, selection algorithm 122a, and exit criteria 124a. Problem set 110b includes problem bank 120b, selection algorithm 122b, and exit criteria 124b. Problem set 110c includes problem bank 120c, selection algorithm 122c, and exit criteria 124c.

### Selecting a Problem Set

Set ordering directive 104 may describe the order in which problem sets 110a-110c are to be completed. One directive is to simply proceed by an ordered list, for example problem set 110a first, 110b second, and 110c third. Another directive may proceed by selecting one problem from a randomly selected problem set, selecting another problem from another randomly selected problem set, and repeating the random selection process until all problem sets are completed, as determined by their respective exit criteria 124a, 124b, and 124c. Yet another directive may mix ordered and random problem set selections. While set ordering directive 104 is shown as part of section 100 in FIG. 1, in alternative embodiments set ordering directive 104 may be specified separately from section 100.

### Selecting Problems Within a Problem Set

Assuming that set ordering directive 104 specifies an ordered traversal through problem sets 110a-110c, problem set 110a may be selected and selection algorithm 122a may be utilized to create a candidate problem list from problem bank 120a. Prior to creating the candidate problem list, a pre-filter may be applied to remove certain questions from problem bank 120a.

Selection algorithm 122a populates the candidate problem list based on the assessed skill set of the user and the learning priorities configured within selection algorithm 122a. The assessed skill set of the user may be stored in user profile 140 and may contain calculated skill levels based on user tutoring history, as well as imputed skill levels based on an expected mastery level according to historical data. For example, a user in the 9^{th} grade may be expected to have a certain baseline proficiency based on historical data showing the average proficiency levels of 9^{th} graders, which may also be tailored to available user demographic data.

As shown in FIG. 1, each problem set 110a-110c has its own respective problem bank 120a-120c. These problem banks may refer to a subsection of problems from the larger problem repository 130. Accordingly, problems are not necessarily mutually exclusive between problem sets, and some problems may be shared across multiple problem sets.

Once a candidate problem list is generated, various secondary factors may be weighed and compared against a threshold to determine whether a particular candidate problem is satisfactory for presentation. If the threshold minimum is met, then the candidate problem may be presented to the user on a display, an answer may be solicited, and the user skill set in user profile 140 may be updated according to the associated cognitive model, which may be retrieved from metadata of problem repository 130. If the answering of the problem triggers exit criteria 124a, then problem set 110a may be marked as “finished” from a default initial state of “unfinished”, and processing of section 100 may proceed to the next problem set, or problem set 110b according to set ordering directive 104. Problem set 110b and 110c may be processed in a similar manner to problem set 110a. If section 100 is completed in multiple sessions rather than in a single sitting, then previously completed and finished problem sets may be skipped. Once all problem sets 110a-110c are processed, then section 100 is complete, and tutoring may proceed to other sections within the course unit, or to a different course unit.

### Skill Matching by Progressive Phases

Note that dividing section 100 into three distinct problem sets 110a-110c allows three progressive phases of section 100 with distinct problem banks, selection algorithms, and exit criteria. While section 100 is divided into three problem sets in FIG. 1, any number of problem sets may be specified to flexibly guide the user through section 100.

Accordingly, problem set 110a may correspond to a “start” or “open” phase where selection algorithm 122a is optimized to introduce a user to the subject matter of section 100. One optimization factor may favor questions that teach skills assumed to be already known by the user, as indicated by user profile 140. Another optimization factor may favor questions that test fewer skills per question. For example, questions that test fewer than 4 distinct skills may be selected, while questions that test 4 or more skills may be filtered out. Yet another optimization factor may favor questions with an explicitly specified low difficulty rating. Still another optimization factor may favor questions known to be effective introductory questions according to empirical data. These optimization factors may be used exclusively or in any weighted combination.

Problem set 110b may correspond to a “middle” phase where selection algorithm 122b is optimized to broaden a user's exposure to the subject matter of section 100. During this phase, one optimization factor used by selection algorithm 122b may cause selection algorithm 122b to avoid selecting questions that are for skills that are already mastered by the user. Another optimization factor may favor questions that test a broad range of skills, a wide variety of skills, or have a high number of skills per question. Yet another optimization factor may favor questions that test novel or untested skills for the user, or skills that have not changed in mastery level since the beginning of the section. As with the prior phase, these optimization factors may be used exclusively or in any weighted combination.

Problem set 110c may correspond to an “end” phase where selection algorithm 122c is optimized to maximize skill mastery of section 100. One optimization factor may select questions providing the fastest overall skill growth towards subject matter mastery, which may favor complex problems exercising multiple skills per question. Another optimization factor may select questions highly focused on greatest skill improvement for a specific skill that is not yet mastered. As with the prior phase, these optimization factors may be used exclusively or in any weighted combination.

### Exit Criteria and Alternative Matching

To define the timing of advancement between different phases of problem sets, exit criteria 124a-124c may each specify one or more exit criteria that can independently trigger the completion of the present problem set. The exit criteria may also be forcibly triggered if all questions are exhausted in a problem bank or a section. Some example exit criteria may include completing a predetermined number of problems in the present set, completing a predetermined number of problems in the section, mastering or reaching a threshold skill level for a certain number or percentage of skills, and improving a certain number or percentage of skills by a certain amount. The exit criteria may also be dependent on the selection algorithm for the problem set. The exit criteria can be set independently for each problem set 110a-110c, or may alternatively be common to all problem sets in the same section 100.

It should be noted that while the majority of problems may exercise the same preset skills for every user, other more open-ended questions may exercise a different variety of skills for each user. For example, geometric proofs and other logic problems may have several valid pathways to a correct answer, but may exercise different skill sets for each pathway. In this case, multiple pathways towards exit criteria may be possible, and it may be desirable to provide more narrow and focused question sets to guide users towards specific skill utilization if open-ended questions fail to exercise the desired areas of skill mastery.

If the problem banks do not contain a sufficiently large number of problems, then it may be possible that an insufficient number of problems are retrieved in the candidate problem list to successfully trigger the exit criteria. In this case, the secondary factors may be weighed against problems that are not skill matched in the problem bank. If this is still insufficient, the secondary factor threshold may be temporarily lowered, or problems may be matched solely based on other criteria, such as user indicated preferences and areas of interest. If no user preference data is available, then problems may be selected based on historical data or random selection. In some embodiments, these secondary factors and other factors may be integrated as part of the primary selection algorithms.

### Section Processing

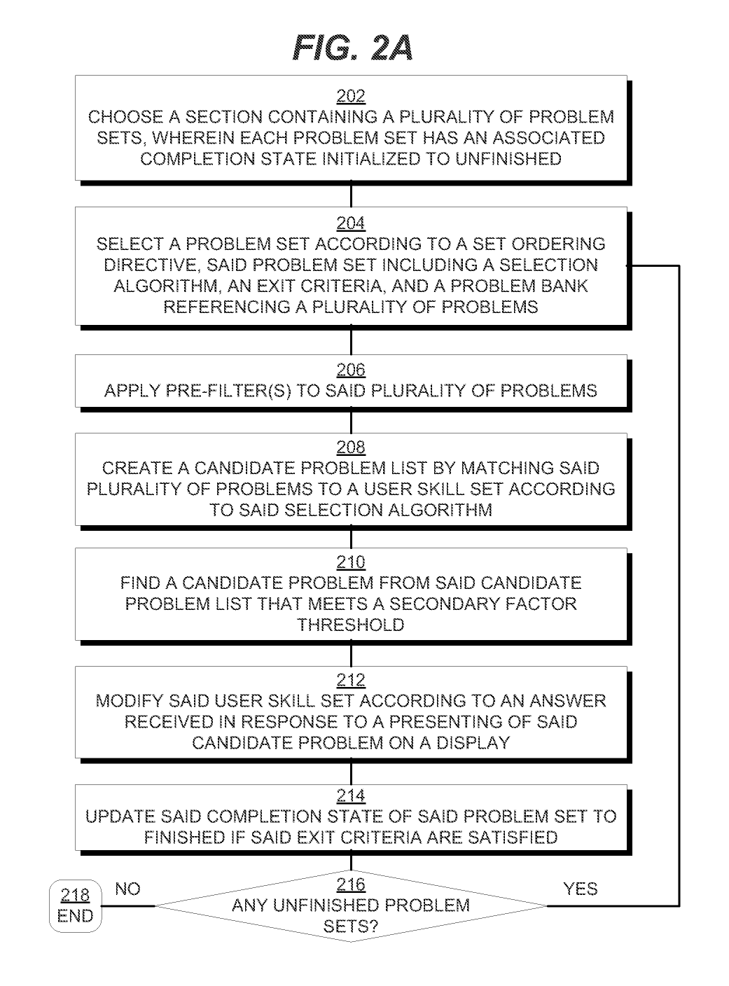

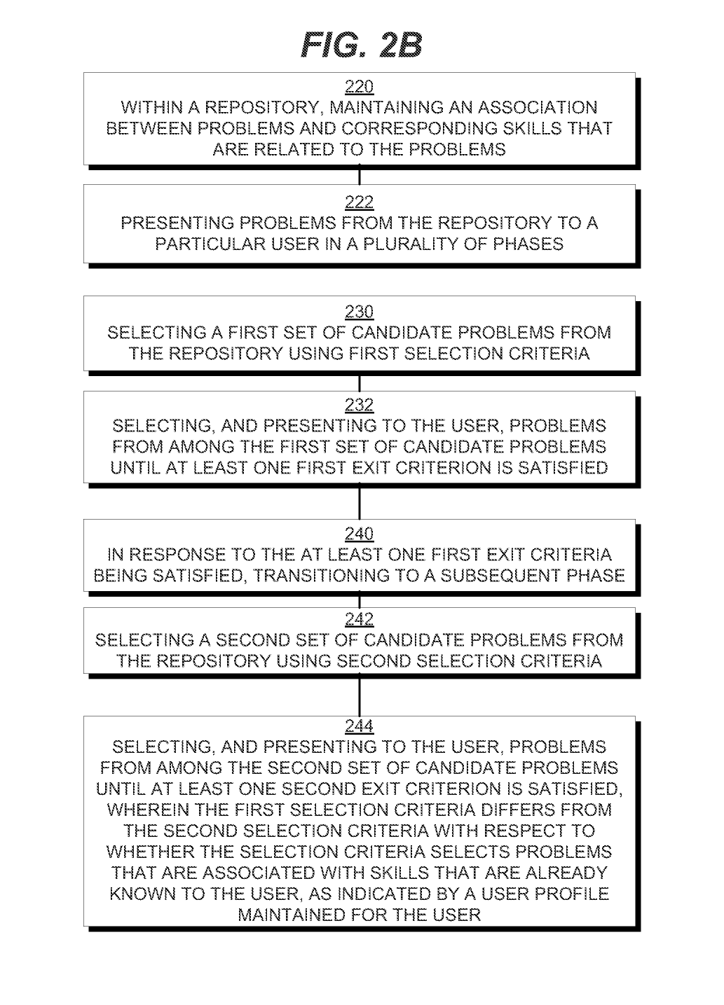

FIG. 2A illustrates a flowchart for processing a course unit section to provide a multi-layered cognitive tutor. Blocks in FIG. 2A may represent logical operations that may be implemented using one or more computer programs hosted on or executed by a general-purpose computer, or an instruction sequence stored in a non-transitory tangible computer-readable medium, or the logical structure of a digital logic in a special-purpose computer or circuit(s), or a combination of one or more of the foregoing.

At block 202, a computing system chooses a section containing a plurality of problem sets, wherein each problem set has an associated completion state initialized to unfinished. For example, in one embodiment, section 100 of FIG. 1 may be chosen.

At block 204, the computing system selects a problem set according to a set ordering directive, the problem set including a selection algorithm, exit criteria, and a problem bank referencing a plurality of problems. For example, in one embodiment, set ordering directive 104 may instruct an ordered traversal through problem sets 110a-110c, resulting in the initial selection of problem set 110a, which includes selection algorithm 122a, exit criteria 124a, and problem bank 120a referencing a plurality of problems, which may be stored in a problem database not shown in FIG. 1. However, as previously discussed, various set ordering directives are possible, and any number of problem sets may be present in a section.

At block 206, the computing system may optionally apply one or more pre-filters to the plurality of problems. For example, in one embodiment, a pre-filter may remove certain special-case problems that should not be selected, such as certain reserved tutorial problems. Another pre-filter may reject duplicate problems that have already been presented to the user for a predetermined number of times. Yet another filter may reject problems that test the same skill as the most recent several problems, helping to space out testing of a particular skill to avoid drilling the same skills repetitively and consecutively, which may fatigue the user.

For example, a pre-filter may decrease the matching score based on the specific scenario or perceptual class demonstrated in the problem. Each problem may be tagged with one or more scenario tags, which indicate how the student is likely to characterize the problem, such as for example “selling used cars on a car lot”, “teddy bear collection”, or “animals at the animal shelter”. In some cases, presenting problems with the same scenario tags may fatigue the user, since the user may feel as if the same problems are being presented repeatedly. Thus, the matching score for problems with repeated scenario tags may be reduced to encourage the selection of a broad variety of problem scenarios, helping to maintain user engagement.

Besides removing or demoting certain questions, pre-filters may also promote the selection of certain questions. One pre-filter may favor the selection of scenarios that have not yet been encountered by the user, thus boosting the matching score of questions having the associated tags in block 208. Another pre-filter may favor the selection of questions related to user provided interests and preferences. For example, the user might indicate an interest in the environment; accordingly, the pre-filter might provide questions with fact-patterns that involve the environment. Yet another pre-filter may favor the selection of occasional humorous problems to provide some comic relief. These pre-filters can be applied singly or in any weighted combination, as desired. In this manner, user engagement can be improved and maintained. The pre-filters may be global to a specific section or independent to each specific problem set.

At block 208, the computing system creates a candidate problem list by matching the plurality of problems to a user skill set according to the selection algorithm. For example, in one embodiment, the computing system may apply selection algorithm 122a to problem bank 120a to create the candidate problem list. As previously discussed, selection algorithm 122a may correspond to a “start” or “open” phase optimized to introduce a user to the subject matter of section 100, for example by favoring questions that teach skills assumed to be already known by the user. Additionally, the pre-filters of block 206 may boost the scores of certain questions, resulting in some questions being added to the candidate problem list that might not otherwise be added based on skill matching alone.

At block 210, the computing system finds a candidate problem from the candidate problem list that meets a secondary factor threshold. For example, in one embodiment, the computing system may calculate a composite score based on factors similar to those used in the pre-filter stage. Thus, for example, questions may be given a numerical rank from 0-100 based on alignment to user provided interests and preferences stored in user profile 140, skill variation from previously presented problems, scenario variation, difficulty appropriate to the tutoring history in user profile 140, and other factors as previously discussed in conjunction with the pre-filter. If the question meets a minimum predetermined threshold, for example 70 points, then the candidate problem is found. If the question does not meet the threshold, the next question in the candidate problem list is scored, and the process repeats until a suitable candidate problem is found. If the candidate problem list is exhausted, alternative matching methods may be utilized, as previously described. Additionally, as previously discussed, some or all of the secondary factors may be integrated into selection algorithms 122a-122c to provide a larger initial candidate problem list.

At block 212, the computing system modifies the user skill set according to an answer received in response to a presenting of the candidate problem on a display. For example, in one embodiment, if the user answers the candidate problem correctly, then the associated skills in the user skill set may be increased, as indicated by the associated conceptual model for section 100. If the user answers the candidate problem incorrectly, then the user skill set may remain the same or may be adjusted downwards, as appropriate.

At block 214, the computing system updates the completion state of the problem set to finished if the exit criteria are satisfied. For example, in one embodiment, exit criteria 124a is examined to see if any criteria are met, in which case problem set 110a is marked as finished. As previously described, problem exhaustion may also forcibly result in exit criteria being met.

At block 216, the computing system determines whether any unfinished problem sets remain in section 100. Thus, the completion state of problem sets 110a, 110b, and 110c are examined. If the resulting answer is yes, then the flowchart returns to block 204. If the resulting answer is no, then the flowchart continues to block 218 and finishes. After block 218, the computing system may move on to process another section or unit, or may end the tutoring session.

SECTION PROCESSING WITH PROGRESSIVE PHASES

While FIG. 2A provides a general tutoring process for a course unit section, it may be helpful to focus on a process that highlights the progressive changes between phases of a course unit section. Accordingly, FIG. 2B illustrates a flowchart for processing through phases of a section to provide a multi-layered cognitive tutor. Blocks in FIG. 2B may represent logical operations that may be implemented using one or more computer programs hosted on or executed by a general-purpose computer, or an instruction sequence stored in a non-transitory tangible computer-readable medium, or the logical structure of a digital logic in a special-purpose computer or circuit(s), or a combination of one or more of the foregoing.

At block 220, a computing system maintains, within problem repository 130, an association between problems and corresponding skills that are related to the problems. As previously discussed, this information may be stored in metadata that is derived from a cognitive model that indicates how particular problems help to improve particular skills

At block 222, the computing system presents problems from problem repository 130 to a particular user in a plurality of phases. All known data concerning the particular user is represented by user profile 140, which may include skill mastery levels, tutoring history, demographic and preference information, and other user data. The particular user may use a client system accessing the computing system, which runs a web browser or a client application that interprets the data from section 100 to provide an interactive tutoring user interface on a display. As shown in FIG. 1, section 100 provides multiple problem sets 110a-110c that may correspond to the plurality of phases.

Blocks 230, 232, 240, 242, and 244 provide a more detailed example process for the process described in block 222. Starting at block 230 and corresponding to a particular phase, a computing system selects a first set of candidate problems from problem bank 120A using selection criteria specified by selection algorithm 122a. As discussed earlier, each problem bank 120a-120c may contain a subsection of problems from problem repository 130.

At block 232, the computing system selects problems from among the first set of candidate problems in block 230 to present to the user until at least one first exit criterion is satisfied from exit criteria 124A. As previously discussed, various secondary criteria and selection filters may be utilized to select from the first set of candidate problems, which are then displayed to the user for solving by the user.

At block 240, in response to the at least one first exit criterion being satisfied, the computing system transitions to a subsequent phase of the particular phase, or from problem set 110A to problem set 110B. Next, the computing system processes through the steps in blocks 242 and 244, which correspond to blocks 230 and 232 respectively, but applied to problem set 110B rather than problem set 110A.

In addition, as indicated by block 244, the first selection criteria, or selection algorithm 122A, and the second selection criteria, or selection algorithm 122B, differ with respect to a particular property. In the example shown in FIG. 2B, the difference is with respect to whether the selection criteria selects problems that are associated with skills that are already known to the user, as indicated by user profile 140 maintained for the user. Thus, if problem set 110A reflects a beginning phase and problem set 110B reflects a middle phase, then selection algorithm 122A may select problems that are associated with skills that are already known to the user, whereas selection algorithm 122B may instead select problems that are associated with skills that are unknown to the user, as indicated by user profile 140. In this manner, the initial phase may gently introduce the user to the section by selecting problems that test familiar concepts, whereas the subsequent phase may start to broaden towards unfamiliar territory to help the user learn new concepts.

An alternative embodiment of block 244 may instead differ with respect to a number of skills that are associated with the selected problems. For example, selection algorithm 122A may select problems associated with a fewer number of skills to introduce and drill the user with specific concepts in isolation, one at a time, whereas selection algorithm 122B may select problems associated with a larger number of skills to encourage broad skill growth and to test whether the user understands how to apply several different concepts to a single problem. Other embodiments of block 244 are also possible, which progressively differentiate the selection criteria between the tutoring phases in various ways to provide a multi-layered cognitive tutor.

### Hardware Summary

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

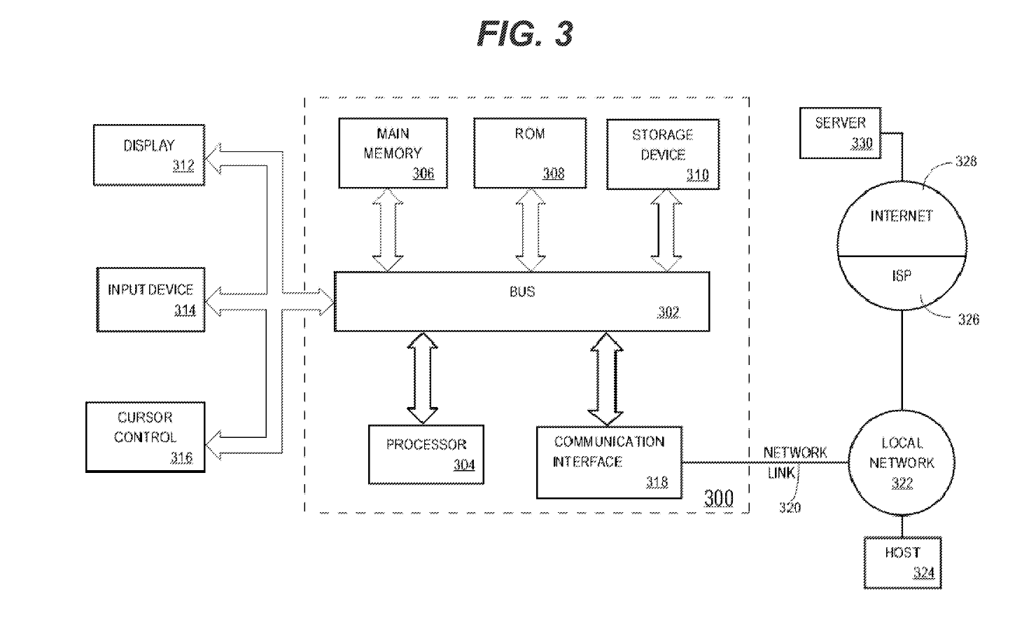

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
within a repository, maintaining an association between problems and corresponding skills that are related to the problems;
presenting problems from the repository to a particular user in a plurality of phases;
wherein presenting the questions to the user includes:
during a first phase of the plurality of phases, performing the steps of:
selecting a first set of candidate problems from the repository using first selection criteria;
selecting, and presenting to the user, problems from among the first set of candidate problems until at least one first exit criterion is satisfied;
in response to the at least one first exit criterion being satisfied, transitioning to a second phase of the plurality of phases;
during the second phase, performing the steps of:
selecting a second set of candidate problems from the repository using second selection criteria;
selecting, and presenting to the user, problems from among the second set of candidate problems until at least one second exit criterion is satisfied;
wherein the first selection criteria differs from the second selection criteria with respect to whether the selection criteria selects problems that are associated with skills that are already known to the user, as indicated by a user profile maintained for the user;
wherein the method is performed using one or more computing devices.

2. The method of claim 1, wherein the skills that are already known to the user are based on an expected mastery level of the user.

3. The method of claim 1, wherein the association is derived from a cognitive model of the problems.

4. The method of claim 1, wherein the user provides an answer in response to the presenting, and wherein the answer updates, in the user profile, a skill set according to the association in the repository.

5. The method of claim 1, wherein the first selection criteria selects problems testing skills of a lower specified difficulty, relative to the second selection criteria.

6. The method of claim 1, wherein the first selection criteria selects problems testing skills of a lesser breadth, relative to the second selection criteria.

7. The method of claim 1, wherein the first selection criteria selects problems testing skills of a lower complexity, relative to the second selection criteria.

8. The method of claim 1, wherein the first selection criteria selects problems providing a lower skill growth in a skill set of the user profile, relative to the second selection criteria.

9. The method of claim 1, wherein the selecting of the problems from among the first set of candidate problems is based on one or more secondary criteria including at least one of:
matching the selected problems to interests and preferences of the user in the user profile;
varying skills of the selected problems from previously presented problems,
varying scenarios of the selected problems from previously presented problems,
matching a difficulty of the selected problems to a tutoring history in the user profile.

10. The method of claim 1, wherein the selecting of the problems from among the first set of candidate problems applies a pre-filter to the repository to remove at least one of:
special-case problems;
problems previously presented to the user for a predetermined number of times;
problems associated with a skill previously presented to the user from previous problems.

11. The method of claim 1, wherein the selecting of the problems from among the first set of candidate problems applies a pre-filter to the repository to promote at least one of:
a problem demonstrating a specific scenario or perceptual class unfamiliar to the user;
a problem related to interests and preferences of the user;
a humorous problem.

12. The method of claim 1, wherein the at least one first exit criterion is one of:
the user answering a predetermined number of problems;
a skill set of the user in the user profile reaching a certain mastery level;
a skill set of the user in the user profile improving by a certain amount.

13. A method comprising:
within a repository, maintaining an association between problems and corresponding skills that are related to the problems;
presenting problems from the repository to a particular user in a plurality of phases;
wherein presenting the questions to the user includes:
during a first phase of the plurality of phases, performing the steps of
selecting a first set of candidate problems from the repository using first selection criteria;
wherein the first selection criteria is based, at least in part, on how many skills correspond to the problems;
selecting, and presenting to the user, problems from among the first set of candidate problems until at least one first exit criterion is satisfied;
in response to the at least one first exit criterion being satisfied, transitioning to a second phase of the plurality of phases;
during the second phase, performing the steps of
selecting a second set of candidate problems from the repository using second selection criteria;
wherein the second selection criteria is based, at least in part, on how many skills correspond to the problems;
selecting, and presenting to the user, problems from among the second set of candidate problems until at least one second exit criterion is satisfied;
wherein the first selection criteria differs from the second selection criteria with respect to a number of the skills that correspond to each of the problems;
wherein the method is performed using one or more computing devices.

14. The method of claim 13, wherein the association is derived from a cognitive model of the problems.

15. The method of claim 13, wherein the user provides an answer in response to the presenting, and wherein the answer updates, in a user profile of the user, a skill set according to the association in the repository.

16. The method of claim 13, wherein the first selection criteria selects problems based on at least one of:
testing skills of a lower specified difficulty, relative to the second selection criteria;
testing skills of a lesser breadth, relative to the second selection criteria;
testing skills of a lower complexity, relative to the second selection criteria;
providing a lower skill growth in a skill set of a user profile for the user, relative to the second selection criteria.

17. The method of claim 13, wherein the selecting of the problems from among the first set of candidate problems is based on one or more secondary criteria including at least one of:
matching the selected problems to interests and preferences of the user in the user profile;
varying skills of the selected problems from previously presented problems,
varying scenarios of the selected problems from previously presented problems,
matching a difficulty of the selected problems to a tutoring history in the user profile.

18. The method of claim 13, wherein the selecting of the problems from among the first set of candidate problems applies a pre-filter to the repository to remove at least one of:
special-case problems;
problems previously presented to the user for a predetermined number of times;
problems associated with a skill previously presented to the user from previous problems.

19. The method of claim 13, wherein the selecting of the problems from among the first set of candidate problems applies a pre-filter to the repository to promote at least one of:
a problem demonstrating a specific scenario or perceptual class unfamiliar to the user;
a problem related to interests and preferences of the user;
a humorous problem.

20. A non-transitory computer-readable medium storing one or more sequences of instructions which, when executed by one or more processors, cause performing of:
within a repository, maintaining an association between problems and corresponding skills that are related to the problems;
presenting problems from the repository to a particular user in a plurality of phases;
wherein presenting the questions to the user includes:
during a first phase of the plurality of phases, performing the steps of:
selecting a first set of candidate problems from the repository using first selection criteria;
selecting, and presenting to the user, problems from among the first set of candidate problems until at least one first exit criterion is satisfied;
in response to the at least one first exit criterion being satisfied, transitioning to a subsequent phase;
during a second phase of the plurality of phases, performing the steps of:
selecting a second set of candidate problems from the repository using second selection criteria;
selecting, and presenting to the user, problems from among the second set of candidate problems until at least one second exit criterion is satisfied;
wherein the first selection criteria differs from the second selection criteria with respect to whether the selection criteria selects problems that are associated with skills that are already known to the user, as indicated by a user profile maintained for the user.
